(19) United States
(12) Patent Application Publication
(10) Pub. No.: US 2025/0239723 A1
(43) Pub. Date: Jul. 24, 2025

(54) METHOD FOR FILLING BATTERY PACK WITH EXPANDING FOAM POTTING USING AIR VENTS BUILT INTO THERMAL RUNAWAY PROPAGATION VENT SYSTEM

(71) Applicant: GM GLOBAL TECHNOLOGY OPERATIONS LLC, Detroit, MI (US)

(72) Inventors: Anthony Michael COPPOLA, Rochester Hills, MI (US); William Thomas KUCINSKI, Windsor (CA); Mohammad Hamza KIRMANI, Troy, MI (US); Kyle James CLARE, Brighton, MI (US); Kris KILLEN, Shelby Township, MI (US); Tyler TALASKI, Clarkston, MI (US); Michael Victor PYRTKO, Ferndale, MI (US); Andrew YONKA, Sterling Height, MI (US); Michael MAES, Berkley, MI (US)

(21) Appl. No.: 18/421,162

(22) Filed: Jan. 24, 2024

(51) Int. Cl. H01M 50/367; H01M 50/209; H01M 50/293

(52) U.S. Cl. CPC H01M 50/367; H01M 50/209; H01M 50/293

(57) ABSTRACT

A battery module includes a housing including a sidewall structure, a top shear plate and a bottom shear plate. A vent tray assembly is disposed within the housing and includes a plurality of cell trays and a plurality of vent trays that combine to define a plurality of vent channels therebetween. The cell trays include a base plate having a plurality of vent openings in communication with one of the plurality of vent channels, the vent tray assembly including an air vent through a seam between the base plates of the cell trays. A plurality of battery cells each include an end with a vent that is aligned with one of the vent openings in the base plate in the cell tray. A potting foam is dispersed within the housing and between the batteries.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to a method for filling a battery pack with expanding foam potting by venting air outside of the potted region.

Cylindrical cell battery packs typically require encapsulating potting material around the cells to provide structural support and thermal runaway propagation protection. Automotive battery packs have utilized a ventilation system that allows individual battery cells to vent through a passage system that isolates the passages from the remaining cells of the battery pack. The vent system must remain open for gas to traverse during a thermal event in order to allow the gas to reach the pack's vent port. Accordingly, during the potting process, the potting needs to be prevented from entering the vent system.

While foam potting is used in several automotive battery packs on the market, voids are common place. Voids can occur as a result of either underfill or entrapped air. The presence of voids may adversely affect thermal runaway performance by allowing migration of inflamed gas between cells or in areas of high voltage, as well as reduce structural performance due to reduced material and uneven distribution. The foam potting is typically composed of a polyurethane, but could also be an epoxy, silicone, or other resin. Potting is dispensed as a liquid resin then expands due to a chemical reaction. After some time, the material is fully expanded and hardens to form a foam plastic material. During expansion, the foam dispenses air, which must be removed from the battery pack to avoid voids in the potting material. However, the air vent ports run the risk of allowing foamed resin to pass, which could result in blockages of the vent areas that must remain without potting.

### SUMMARY

According to the principles of the present disclosure, potting is dispensed around and within the battery module. Air is pushed towards strategically located vent passages formed through overlap joints in the vent tray assembly.

According to an aspect of the present disclosure, a battery module includes a housing including a sidewall structure, a top shear plate and a bottom shear plate. A vent tray assembly is disposed within the housing and includes a plurality of cell trays and a plurality of vent trays that combine to define a plurality of vent channels therebetween. The cell trays include a base plate having a plurality of vent openings in communication with one of the plurality of vent channels, the vent tray assembly including an air vent through a seam between the base plates of the cell trays. A plurality of battery cells each include an end with a vent that is aligned with one of the vent openings in the base plate in the cell tray. A potting foam is dispersed within the housing and between the batteries.

According to a further aspect, the cell tray includes a plurality of parallel ribs extending from the base plate of the cell tray and the vent tray includes a base plate and a plurality of parallel ribs that extend from the base plate of the vent tray, and the plurality of parallel ribs of the cell tray and the plurality of parallel ribs of the vent tray combine to form the plurality of vent channels.

According to a further aspect, the air vent includes a plurality of air vents each including a protruding hood extending from an edge of the base plate of the cell tray.

According to a further aspect, a layer of mica covers the base plates of the cell tray and wherein the air vent is defined between a seam between the cell trays and the layer of mica.

According to a further aspect, a semi-permeable media extends between rows of the plurality of battery cells and adjacent to the plurality of cell trays.

According to a further aspect, the battery cells are one of cylindrical and prismatic type.

According to a further aspect, the air vent includes a plurality of air vents located in a center region of the battery housing.

According to a further aspect, the air vent is less than 1 mm wide in at least one direction.

According to a further aspect, the vent tray includes a base plate and a plurality of pairs of parallel ribs that align with a respective one of a plurality of parallel ribs of the cell tray to define the plurality of vent channels.

According to a further aspect, the air vent is formed by overlapping step features along adjacent edges of the base plate of the cell trays.

According to another aspect, a method of making a battery module includes inserting a plurality of battery cells into an upside down housing having a top shear plate and a sidewall structure. A vent tray assembly is placed on top of the batteries, the vent tray assembly includes a plurality of cell trays and a plurality of vent trays that combine to define a plurality of vent channels therebetween, the cell trays each include a base plate having a plurality of vent openings in communication with one of the plurality of vent channels, the cell trays including an air vent through a seam between the cell trays. A potting foam is dispensed into the housing in a pattern that causes the potting foam to reach the air vent after substantially all of the air within the housing has passed through the air vent.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a cross-sectional view of a portion of a battery pack with venting for a potting region according to the principles of the present disclosure;

FIG. 2 is a cross-sectional view of a gas ventilation tray system with air venting through a seam in the gas ventilation tray for a potting region according to the principles of the present disclosure;

FIG. 3 is a cross-sectional view of an air venting system in a seam in the gas ventilation tray according to the principles of the present disclosure;

FIG. 4 is a schematic view of a battery pack illustrating an example of the potting dispense locations according to the principles of the present disclosure;

FIG. 5 is a cross sectional view of the battery pack showing an example of the potting dispense locations according to the principles of the present disclosure;

FIG. 6 is a perspective view of a portion of a cell tray of the gas ventilation tray system;

FIG. 7 is a perspective view of a portion of a cell tray of the gas ventilation tray system covered with mica;

FIG. 8 is a partial cross-sectional view of a portion of the battery module showing the placement of an open cell foam between the battery cells;

FIG. 9 is a perspective view of the placement of open cell foam between the battery cells;

FIG. 10 is a top perspective view of a vent passage along a seam of a cell tray;

FIG. 11 is a bottom perspective view of a vent passage along a seam of a cell tray; and

FIG. 12 is a bottom plan view of the cell tray assembly showing the location of vent passages along a seam thereof.

In the drawings, reference numbers may be reused to identify similar and/or identical elements.

### DETAILED DESCRIPTION

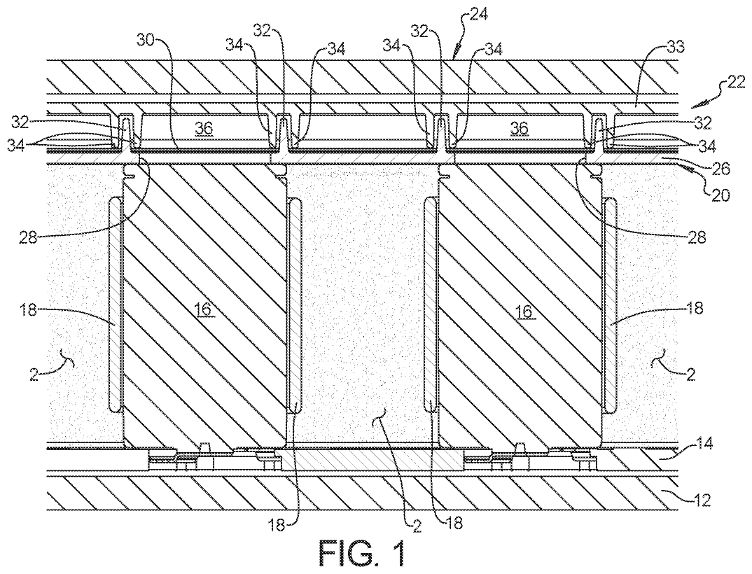

With reference to FIG. 1, a partial cross-sectional view of a battery module 10 is shown in an upside-down state for receiving potting and including an upper shear plate 12 and an integrated circuit board 14. A plurality of battery cells 16 are disposed on top of the integrated circuit board 14. A plurality of cooling ribbons 18 can be disposed between the battery cell rows for cooling the battery cells 16. A cell tray 20 is disposed on top of the battery cells 16 and a vent tray 22 is engaged with the cell tray 20. A bottom shear plate 24 is on top of the vent tray 22 when the battery module 10 is upside down as shown in FIG. 1.

The cell tray 20 includes a base plate 26 having a plurality of vent openings 28 that each align with one of the battery cells 16. A layer of mica 30 is disposed over the vent openings 28. The cell tray 20 further includes a plurality of parallel ribs 32 extending from the base plate 26. The vent tray 22 includes a base plate 33 and a plurality of pairs of parallel ribs 34 that each receive one of the plurality of parallel ribs 32 of the cell tray 20 therebetween. The ribs 32 of the cell tray 20 and the ribs 34 of the vent tray 22 combine to define a plurality of parallel vent channels 36 that align with a plurality of the vent openings 28. The parallel vent channels 36 allow the individual battery cells 16 to vent through the layer of mica 30 and the vent openings 28 while the vent channels 36 isolate the remaining battery cells 16 of the battery pack 10.

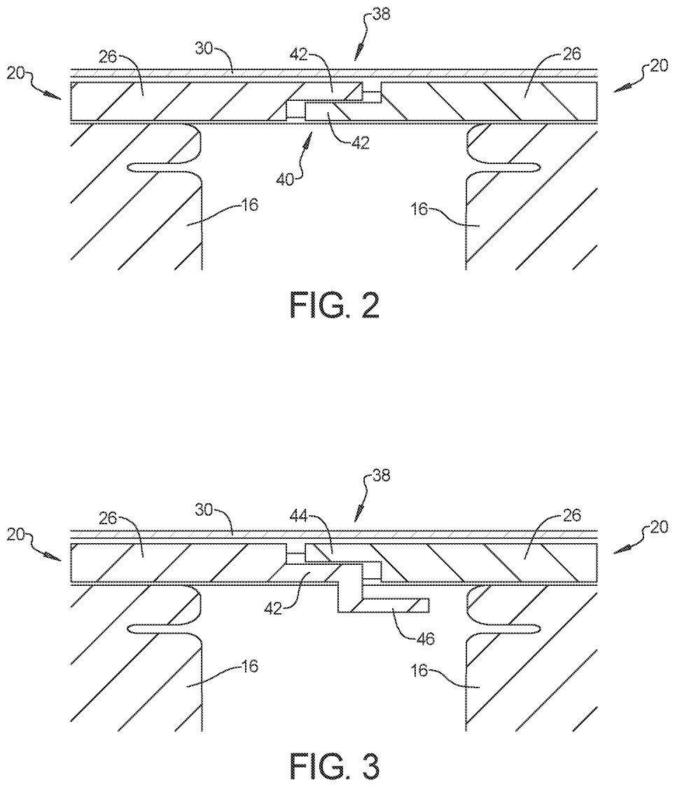

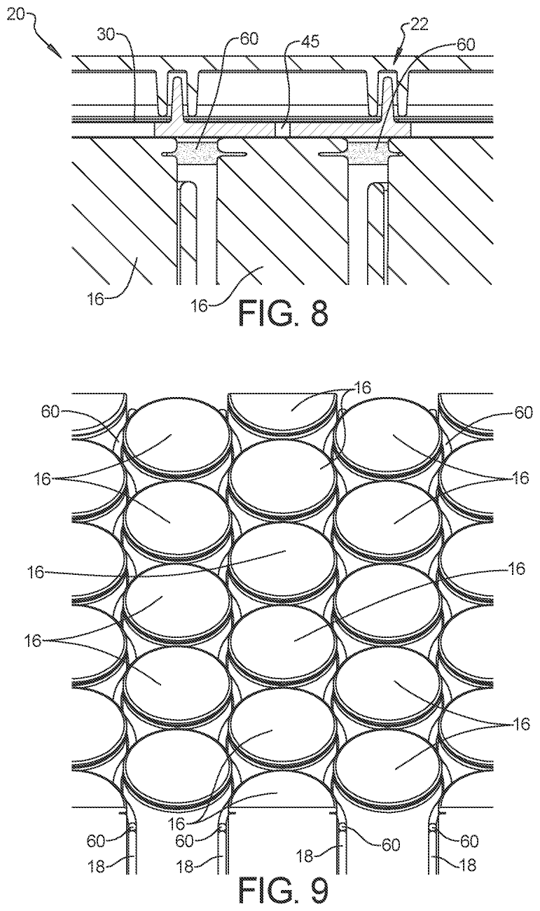

With reference to FIG. 2, a seam 38 is provided between adjacent base plates 26 of the cell trays 20. An air vent 40 is provided through the seam 38 to allow air to escape the housing when the potting 2 is dispensed into the housing. In particular, the potting can be dispensed as a resin and then reacts, expanding into a foam 2. The foam displaces the air within the module 10 and the air is removed through the air vent 40. The air vent 40 can be formed by overlapping step features 42, 44 along adjacent edges of the base plate 26 of the cell trays 20. A gap of less than 1 mm can be provided between the overlapping step features 42, 44. One step feature 42 includes a recessed region on a bottom surface of the base plate 26 and the other step feature 44 includes a recessed region on a top surface of the base plate 26. Alternatively, a hole 45 (see FIG. 8) can be provided in the base plate to allow the air to vent.

With reference to FIG. 3, a protruding hood 46 can extend downward from the edge of the base plate 26 of one of the cell trays 20 to cover the air vent 40 through the seam 38 or other hole 45. The protruding hood 46 along with the overlapping step features 42, 44 define a tortuous path for the air to vent from the battery module 10.

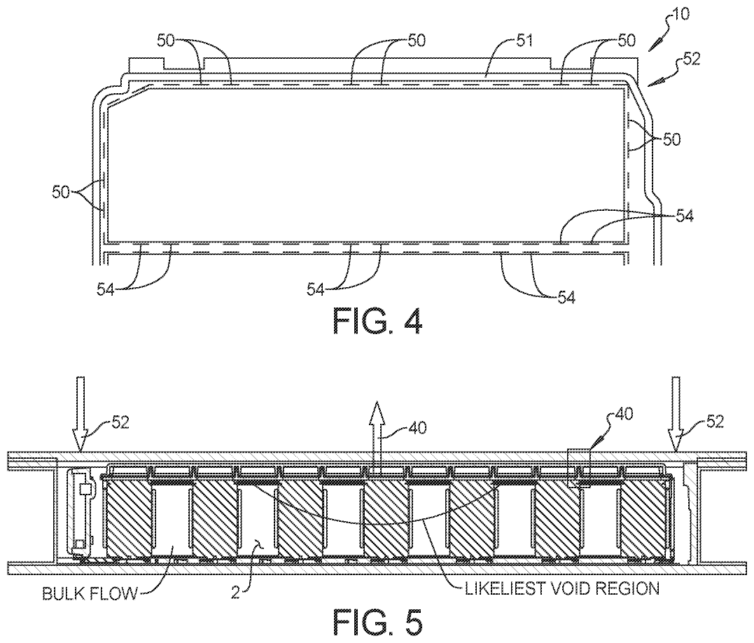

With reference to FIGS. 4 and 5, the battery module 10 is schematically shown with the potting dispense locations illustrated at numerous locations 50 around a perimeter of a sidewall structure 51 and down a center of the housing 52. Additional dispense locations 54 can be provided within an intermediate portion of the housing 52, as shown. As the potting 2 is dispensed as a resin, it interacts with the air and chemically changes to an expanding foam that displaces the air from the housing 52. As the foam expands the air is expelled from the air vent(s) 40 in the seam 38. The air vents 40 are located at a center location and the potting 2 dispense location 50, 54 are located to allow the potting foam to expand and expel substantially all of the air from the housing 52 prior to the potting foam reaching the air vents 40, 45.

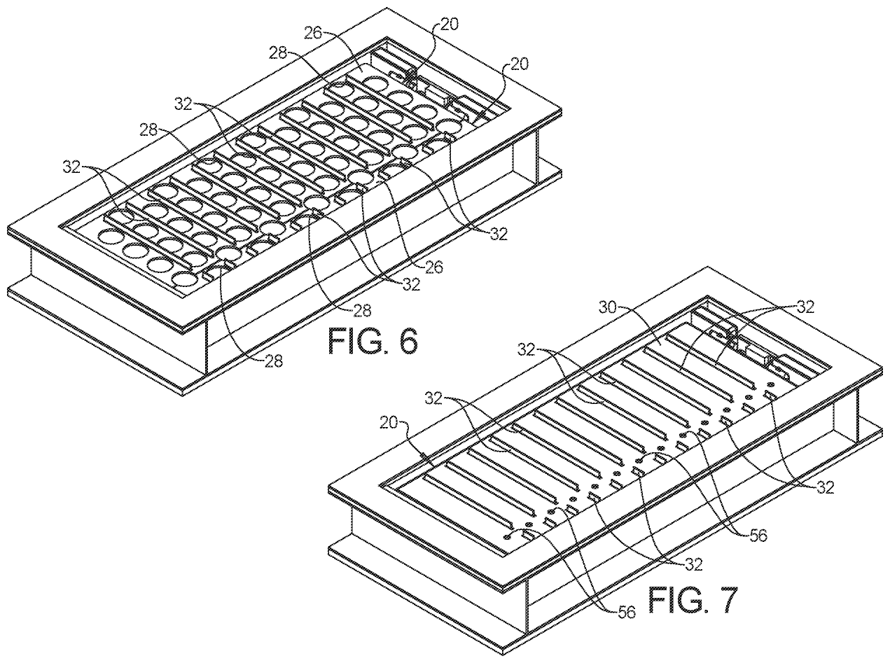

With reference to FIGS. 6 and 7 a perspective view of a portion of a cell tray 20 of the gas ventilation tray system is shown including a plurality of parallel ribs 32 disposed between a plurality of rows of vent openings 28 in the base plate 26 of the cell tray 20. FIG. 7 is a perspective view of the cell tray 20 of the gas ventilation tray system covered with a layer of mica 30. The mica 30 has slots 56 that receive the parallel ribs 32 of the cell tray 20. The mica 30 blocks the vent openings 28 in the cell tray 20 and is opposed to the vent end of the battery cells 16. If a battery cell 16 experiences a thermal event that causes a bursting of the cell vent, the mica bursts to allow the battery cell to vent into the vent channel 26. The mica 30 can be used to further channel away air venting through an air vent 40 in the seam 38 between the cell trays. In particular, the mica can include vent holes 56 to allow air to escape from the air vents 40 in the seam 38 or other hole 45.

With reference to FIGS. 8 and 9, a semi-permeable media 60 such as open cell foam, felt, woven or knit fabric, non-woven, paper or other selected membrane materials can be inserted in between the rows of battery cells 16 and/or overtop of the seam 38 at the air vents 40. The semi-permeable media 60 allows air to pass through, but blocks the passage of potting foam that is injected into the battery module 10.

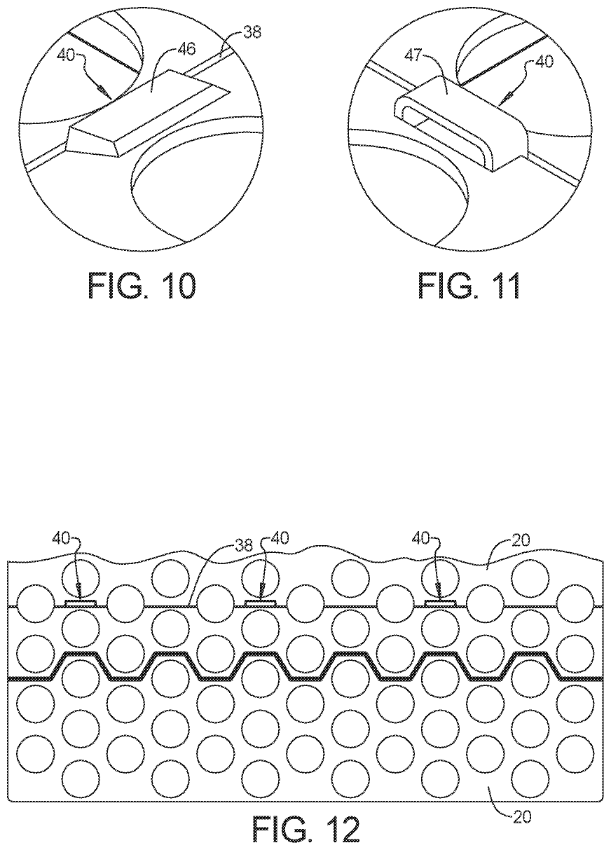

FIG. 10 is a bottom perspective view of an optional protruding hood feature 46 formed at an air vent 40 in the seam 38 of the cell trays 20. FIG. 11 is a top perspective view of the air vent 40 having an optional protruding hood feature 47 formed in the seam 38 of the cell trays 20. FIG. 12 is a plan view of the cell trays 20 showing a location of a plurality of vent features 40 formed in a seam 38 of the cell trays 20.

The thermal vent system is sealed by the potting following pack manufacture to ensure the gas ejected by a cell during a thermal event stays within the vent system. Wherein the openings in this path are less than 1 mm wide in at least one direction, or ideally less than 0.1 mm

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A battery module, comprising:
a housing including a sidewall structure, a top shear plate and a bottom shear plate;
a vent tray assembly disposed within the housing and including a plurality of cell trays and a plurality of vent trays that combine to define a plurality of vent channels therebetween, the cell trays including a base plate having a plurality of vent openings in communication with one of the plurality of vent channels, the vent tray assembly including an air vent through one of a hole in the base plate and a seam between the base plates of the cell trays;
a plurality of battery cells each having an end with a vent that is aligned with one of the vent openings in the base plate in the cell tray; and
a potting foam dispersed within the housing and between the batteries.

2. The battery module according to claim 1, wherein the cell tray includes a plurality of parallel ribs extending from the base plate of the cell tray and the vent tray includes a base plate and a plurality of parallel ribs that extend from the base plate of the vent tray, and the plurality of parallel ribs of the cell tray and the plurality of parallel ribs of the vent tray combine to form the plurality of vent channels.

3. The battery module according to claim 1, wherein the air vent includes a plurality of air vents each including a protruding hood extending from an edge of the base plate of the cell tray.

4. The battery module according to claim 1, further comprising a layer of mica covering the base plates of the cell tray and wherein the air vent is defined between a seam between the cell trays and the layer of mica.

5. The battery module according to claim 1, further comprising a semi-permeable media extending between rows of the plurality of battery cells and adjacent to the plurality of cell trays.

6. The battery module according to claim 1, wherein the battery cells are one of cylindrical and prismatic type.

7. The battery module according to claim 1, wherein the air vent includes a plurality of air vents located in a center region of the battery housing.

8. The battery module according to claim 1, wherein the air vent is less than 1 mm wide in at least one direction.

9. The battery module according to claim 1, wherein the vent tray includes a base plate and a plurality of pairs of parallel ribs that align with a respective one of a plurality of parallel ribs of the cell tray to define the plurality of vent channels.

10. The battery module according to claim 1, wherein the air vent is formed by overlapping step features along adjacent edges of the base plate of the cell trays.

11. A method of making a battery module, comprising:
inserting a plurality of battery cells into an upside down housing having a top shear plate and a sidewall structure;
placing a vent tray assembly on top of the batteries, the vent tray assembly including a plurality of cell trays and a plurality of vent trays that combine to define a plurality of vent channels therebetween, the cell trays each including a base plate having a plurality of vent openings in communication with one of the plurality of vent channels, the cell trays including an air vent through one of a hole in the base plate and a seam between the cell trays;
dispersing a potting foam into the housing in a pattern that causes the potting foam to reach the air vent after substantially all of the air within the housing has passed through the air vent.

12. The method according to claim 11, wherein the cell trays include a plurality of parallel ribs extending from the base plate of the cell trays and the vent trays include a base plate and a plurality of parallel ribs that extend from the base plate of the vent trays, and the plurality of parallel ribs of the cell trays and the plurality of parallel ribs of the vent trays combine to form the plurality of vent channels.

13. The method according to claim 11, wherein the potting foam is dispensed around a perimeter of the housing.

14. The method according to claim 11, wherein the air vent includes a plurality of air vents each including a protruding hood extending from an edge of the base plate of the cell tray.

15. The method according to claim 11, wherein the air vent is in a center region of the housing.

16. The method according to claim 11, wherein the air vent is less than 1 mm wide in at least one direction.

17. The method according to claim 11, wherein the air vent is formed by overlapping step features along adjacent edges of the base plate of the cell trays.

18. The method according to claim 11, wherein the battery cells are one of cylindrical and prismatic type.

19. The method according to claim 11, further including placing a semi permeable media between rows of the battery cells.

20. The method according to claim 11, further including placing a layer of mica over the plurality of base plates of the cell trays.
